(19) United States
(12) Patent Application Publication
(10) Pub. No.: US 2024/0086167 A1
(43) Pub. Date: Mar. 14, 2024

(54) METHOD AND SYSTEM FOR PROVIDING FUNCTIONS FOR A CUSTOMER'S TERMINAL DEVICE

(71) Applicant: Filippo ADAMO, Wuppertal (DE)

(72) Inventor: Filippo ADAMO, Wuppertal (DE)

(21) Appl. No.: 18/367,160

(22) Filed: Sep. 12, 2023

(30) Foreign Application Priority Data
Sep. 13, 2022 (DE) 10 2022 123 290.5

(51) Int. Cl. G06F 8/61; G06N 3/04

(52) U.S. Cl. CPC G06F 8/61; G06N 3/04

(57) ABSTRACT

A method for providing functions for the terminal device of a customer, including the steps of: registering a functional configuration desired by the customer, in particular using a management system; creating or providing at least one hardware module, in particular protected by a housing, which has at least one controller and one neural unit as a physical representation of a neural network, in consideration of the requested functional configuration; connecting the hardware module to a knowledge base with digitized expert knowledge, which expert knowledge in particular can or may be assigned or related to the special field (of expertise) of the terminal device; and connecting the hardware module to the terminal device.

According to a first aspect, the invention relates to a method for providing functions of a provider for the terminal device of a customer.

Methods of this kind are well-known from the prior art:

For example, there is the task of a customer ordering a hardware chip from a hardware developer, which chip is configured in a specific way, and which is embedded in a terminal device of the customer in such a way that it can perform the previously ordered function in said device.

Systems are also known from the prior art in which customers can download certain ready-made applications from the homepages of software developers and add them to their terminal device.

Such methods generally work reliably although they can sometimes seem very inconvenient, both on the side of the customer and on the side of the provider.

On the provider side in particular, there can be the problem that desired functions always have to be created or built or programmed completely anew, although similar solutions already exist on the market. On the customer side, there is often the problem that the results do not meet the customer's requirements or do not seem well thought-out or “intelligent” enough.

Accordingly, the object of the present invention is to provide a method that can provide sophisticated functions in a simple manner to a customer in a way as simple as possible.

According to the invention, the object is achieved according to the first aspect by a method according to claim 1, which in particular comprises the following method steps:
registering a functional configuration desired by the customer, in particular using a management system,
creating or providing or selecting at least one hardware module, in particular protected by a housing, which comprises at least one controller and a neural unit as a physical representation of a neural network, in consideration of the desired functional configuration,
connecting the hardware module to a knowledge base with digitized expert knowledge, which expert knowledge can be assigned in particular to the field of expertise of the terminal device,
connecting the hardware module to the terminal device.

In other words, the idea of the method according to the invention is to combine for the first time the physical representation of a neural network for the creation of a hardware node with a so-called knowledge base, and thus to provide overall an AI solution through which the provision of functions for terminal devices of a customer is achieved using a distributed, intelligent infrastructure.

Thus, the basic idea of the invention is a hardware module comprising at least one controller and one neural unit, wherein the latter is to be understood as a physical representation of a neural network.

Said neural network may for example have been trained by the provider themselves, for example using said management system. Alternatively, it may even have been trained by the customer themselves. Finally, it is also possible that an existing neural network is used. The trained or selected neural network is then made available in a physical representation as a neural unit with a hardware module.

In particular, the neural network can be a so-called “spiking neural network”, which is based, for example, on the Morris-Lecar neuron or the Leaky Intergrate and Fire neuron.

In particular, by using non-hierarchical spiking neural networks, it becomes possible to consider only the relevant path in the neural network instead of having to traverse the entire neural network, so that an overall energy saving can be achieved.

Alternatively, of course, any other suitable neural network can be used.

The physical representation of the neural network is then assigned to and provided by the hardware module.

The hardware module further comprises at least one controller, which in particular forwards a data signal to the neural unit and initiates the formation of inference chains. At the same time, the controller can transmit the results of corresponding evaluations to the terminal devices.

For this purpose, the hardware module by nature typically also comprises other required electronic components such as connectors, ports, communication interfaces (e.g. USB, COM, LAN or similar) passive elements, power supply units and the like.

In particular, certain elements, in particular the controller or a controller chip providing it, can be provided in plural in order to increase fail-safety.

According to a particularly preferred embodiment of the invention, it is even provided that the knowledge base with digitized expert knowledge is also (physically) integrated into the hardware module. Thus, corresponding elements for providing or storing the knowledge base can be provided on the hardware module.

Alternatively, it is also within the scope of the invention that actually the knowledge base is not integrated into the hardware module, but that the hardware module (in particular the controller) can (merely) access the knowledge base. Said base can for example be stored or provided on a server of the provider or in another suitable location (in particular also as a distributed data set).

The knowledge base is a collection of expert knowledge that is related in particular to the field of expertise of the terminal device. In this context, the expert knowledge does not explicitly refer to the way of operating of the terminal device, but more generally to the (technical) field in which the terminal device is used.

For example, if the terminal device is a medical device, the expert knowledge may contain information on how to interpret the data (for example, of a patient) obtained using the medical device (for example, which disease they indicate) or the like.

In particular, the knowledge base thus contains expert knowledge for the evaluation or interpretation of data (material) that is collected, measured or provided by the terminal device.

It is digitized, in particular (only) machine-readable, knowledge, for example provided as TMS (Truth Maintenance System), Bayesian network(s), Markov networks or probabilistic networks, default logic, propositional logic, predicate logic or similar.

Typically, in a method according to the invention, not only one hardware module is provided, but multiple hardware modules, which can for example be arranged in a common housing (such as a server cabinet or the like), or may also be arranged at different locations (in particular distributed around the world).

These hardware modules can, for example, each represent a (hardware) node in a type of domain tree. Depending on the customer's desired functional configuration, one or more nodes can then be assigned to the configuration in a domain or functional structure, which together or alone implement the desired functions.

In this context, a structure can be provided in such a way, that certain nodes of this structure build on each other and a node can, for example, refer to elements or functions of a hierarchically higher-order node.

Since said nodes can always be assigned to in each case one (or more) hardware module(s), (in particular, multiple nodes can be assigned to one hardware module), the provider can automatically or manually assign corresponding hardware modules (since these represent the nodes in each case) to the customer's desired functional configuration, in order to this way provide a desired functional configuration.

According to the invention, the hardware module is connected to the terminal device.

This can for example take place by embedding the hardware module in the terminal device, i.e. physically mounting it into the terminal device (for example, plugging it into a robot or similar).

In this case, the terminal device can form the housing of the hardware module, in particular. Optionally, the hardware module can also have its own, distinct housing in this case.

Preferably, however, the hardware module can be connected to the terminal device in other ways, for example via a wireless connection, e.g., via an Internet or Ethernet connection or mobile communications (e.g. 5G) or via other wireless or wired connections.

A decision on the type of connection depends in particular on what is required from the terminal device, for example, whether real-time data must be used, in which case one would probably rather embed.

According to the invention, the knowledge base is connected to the hardware module. In particular, the knowledge base can be integrated or embedded in the hardware module.

For example, the hardware module may have a module in the type of a knowledge base or the like. Alternatively, the hardware module may also be wirelessly connected to the knowledge base, for example via the above-mentioned technologies such as the Internet, mobile communication or the like.

In one embodiment, in which the knowledge base is embedded in the hardware module, the knowledge base can in particular be embedded in the neural unit.

The hardware module is provided or created or selected according to the invention.

Depending on the application and customer preference, it may occur that the desired functions can already be provided by the provider's ready-made hardware modules. In this case, one or multiple hardware modules are simply provided.

If the functions are not yet available at the provider, a corresponding hardware module can be created. For this purpose, in particular a neural network or its physical representation can be stored on a hardware module.

According to the invention, at least one hardware module is provided or created. Typically, however, multiple hardware modules are actually provided, either together in a housing or in distributed locations. In this context, for example, multiple hardware modules can be arranged in a (server) cabinet or hardware park or the like.

For example, the controller can be configured as a controller chip and be present/embedded in the hardware module. For example, an application-specific integrated circuit (ASIC) and/or microprocessors can be used.

The invention further relates to a management system that allows registering/receiving a functional configuration desired by the customer.

Furthermore, the management system can assign corresponding nodes in a function structure or corresponding hardware modules to the customer request and/or refer to them.

In particular, the management system can be located on the provider side and refer to the existing hardware modules, especially those that are not integrated into the terminal device.

In particular, the management system manages the structure of the functions (for example, in the type of a function tree), i.e. the hardware nodes.

The management system can also register connected customer devices or terminal devices (for example, for the purpose of managing the entire system and/or for billing purposes). Finally, the management system can also comprise means required for the set-up and/or training a neural network, and/or means for building a corresponding knowledge base (in particular through digitization of expert knowledge).

The method according to the invention can provide one or multiple functions to one or more terminal devices of a client. In particular, the terminal device may be a machine, a vehicle, a robot, a cell phone, a portable computer such as a tablet, a medical device or equipment, or a drone or the like.

According to a preferred embodiment of the invention, the terminal device in this case has its own operating system, in particular, this operating system can be in communication and/or connected with the provider's management system.

According to a further aspect of the invention, the object is achieved by a system according to claim 9.

Part of the system is in particular also a subsystem, which can be referred to as “management system”.

With regard to the system claim, it should be noted that all features and advantages described in conjunction with the method according to the invention can of course also apply to the system according to the invention and vice versa.

All advantages and features are not repeated here, merely for reasons of clarity and are to be regarded in each case as to be disclosed also for the other method/system.

At this point, the following comments and optional features should also be mentioned in brief summary with regard to the method/system according to the invention:
Routing of incoming and outgoing data based on a routing ID can take place;
The neuron model can be flexible and/or be updated in a modular way;
The knowledge base consists of the entirety of acquired knowledge in the domains, and should be consistent;
Elementary skills can be called up and combined as required;
This allows the provider to offer skill bundles to customers based on their specific needs;
By using non-hierarchical Spiking neural networks as an example, it may become possible to consider only the relevant path in the neural network instead of traversing the complete neural network (energy saving);
It is therefore a combination of neural networks and a knowledge-based system, or rather a
hybrid infrastructure of system software and hardware nodes;
The (management) system can be configured in multiple parts and/or provide the following services:
   Training of the neural networks
   Monitoring the precision and stability of the infrastructure
   Redundant architecture for the purpose of fail-safety
   Hardware nodes with desired functionality is assigned to a terminal device (if requested)
   Monitoring
   Integration of expert knowledge, creation of digitized knowledge via client software
The hardware side in particular performs the following functions:
   Evaluating input data and feed it into the neural network
   Evaluating classification data of the neural network in the (local) knowledge base
   Providing and outputting inference data
   Communicating with customer terminal devices (smartphones, machines, computers, etc.)
   Communicating with the mother system/management system
   Providing interfaces for various protocols
   Ensuring fail-safety
In this context, intelligent system software preferably manages an arbitrarily scalable number of hardware nodes that assume and implement the inference task of the system and communicate with the system software in the process;
In particular, the hardware nodes read in data from the user/customer and perform a classification by the associated neural network; an inference chain is then created from the result of the classification using the knowledge (expert knowledge) assigned to the same hardware node (e.g., conclusion, diagnosis, etc.);
In particular, the hardware nodes are implemented as a unit of a controller chip and a neural unit (physical representation of the neural network) as well as the necessary electronic components (connectors, passive elements, power supply, etc.) and a housing (either individual housing or server tower);
In particular, the controller routes incoming data to the neural unit and causes formation of the inference chain, and the results of the evaluation are preferably transmitted to the customer terminal devices via the controller;
It is also possible for the provider to develop its own hardware (so-called ASIC) for both the controller and the neural unit; it is also conceivable (in particular in a prototype stage) to use existing elements such as microprocessors (controller) or even FPGAs (for the neural unit);
Depending on the requirements, the hardware nodes can be operated autonomously or integrated as an embedded system in a larger technical object, e.g. a vehicle, aircraft, drone, robot, machine;
For the communication between infrastructure, hardware nodes and terminal devices, different technologies can be used depending on the use case and requirements (real-time, etc.), communication via Internet (Ethernet), mobile communication (5G), USB, fieldbus (embedded systems) etc.;
Preferably, a domain tree is provided (topological structure of the infrastructure), with the help of which all hardware nodes could be managed and the connected customer devices could be registerable (for the purpose of managing the system and for billing); the management system can also include means for set-up and training neural networks and for building a knowledge base (digitization of expert knowledge).

Further advantages of the invention will be apparent from the dependent claims (not cited) and from the following description of the exemplary embodiments illustrated in the Figures. The Figures show in:

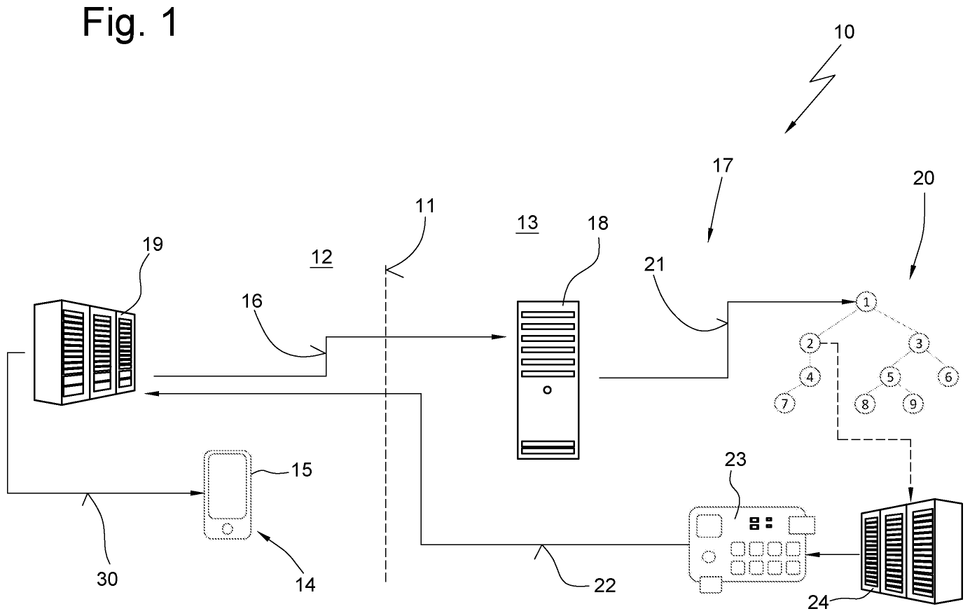

FIG. 1 a highly schematic view in the type of a diagram of a system according to the invention with a smartphone as the terminal device,

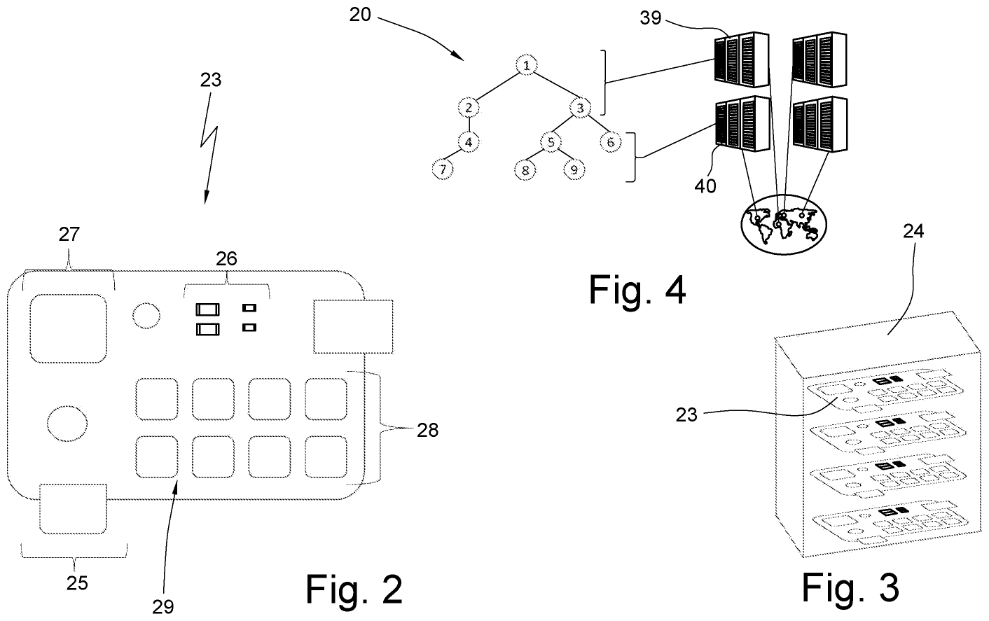

FIG. 2 a more detailed, highly schematic view of the hardware module shown in FIG. 1,

FIG. 3 in a highly schematic, oblique (partially) transparent view, a housing with four hardware modules according to FIG. 2,

FIG. 4 a highly schematic view of a distribution model for the hardware modules,

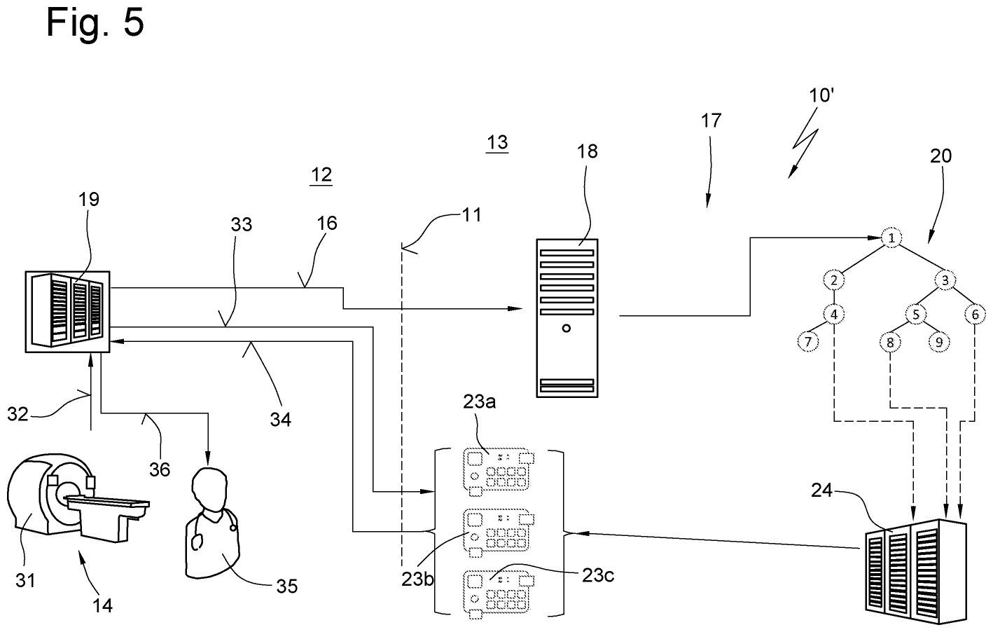

FIG. 5 in a view, approximately according to FIG. 1, an alternative embodiment of the method according to the invention, wherein the terminal device is designed as an MRI system,

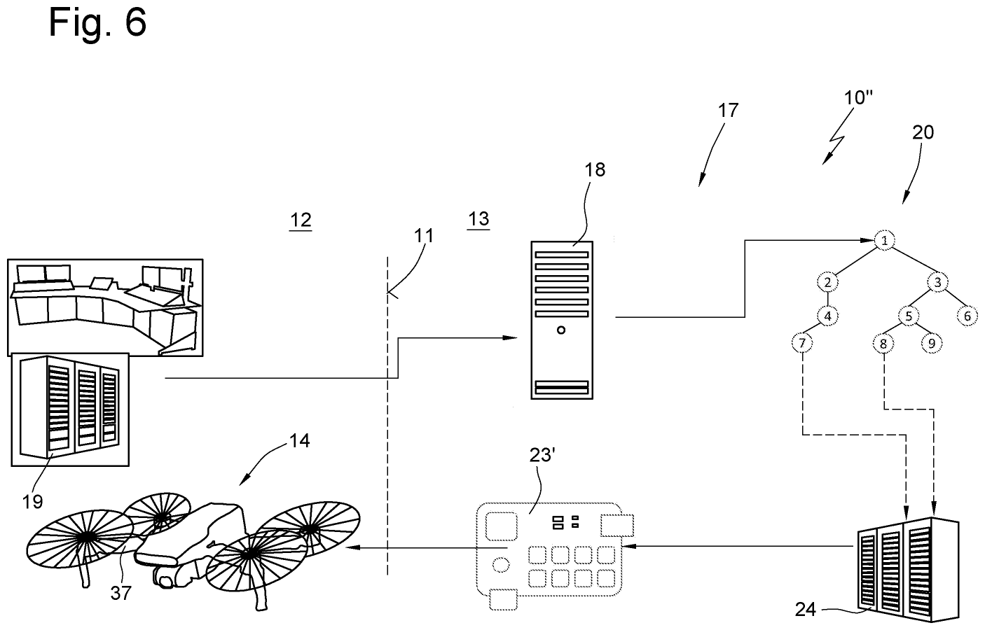

FIG. 6 the system according to the invention in an alternative exemplary embodiment, wherein the terminal device is designed as a drone and

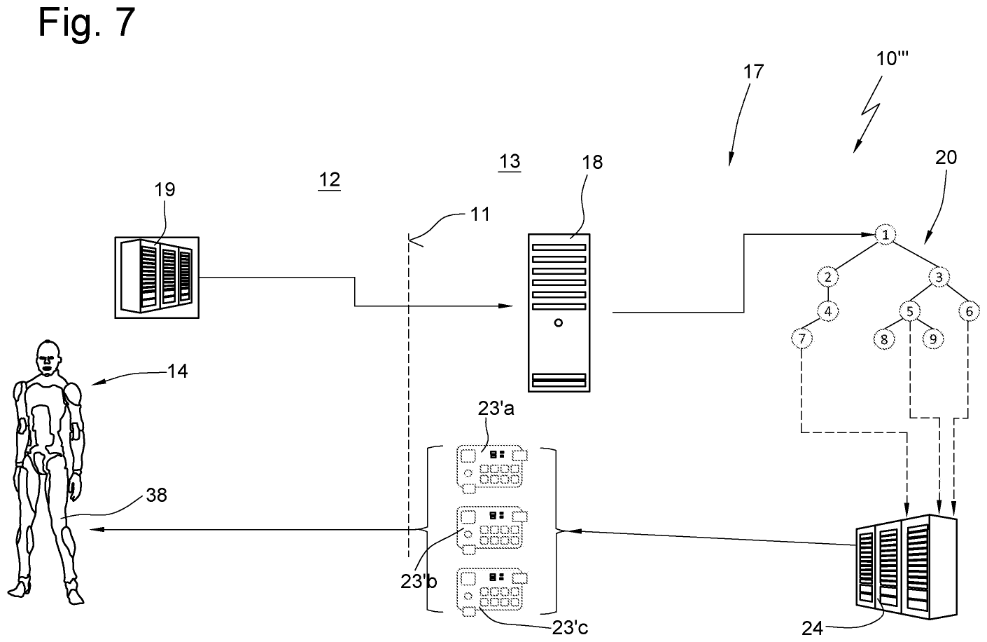

FIG. 7 an alternative embodiment of the system according to the invention, in which the terminal device is designed as a robot.

Exemplary embodiments of the invention are described by way of example in the following description of the Figures, also with reference to the drawings. For the sake of clarity—also as far as different exemplary embodiments are concerned—identical or similar parts or elements or regions are denoted with the same reference characters, sometimes with the addition of lower-case letters or apostrophes.

Features described only in relation to one exemplary embodiment may also be provided in any other exemplary embodiment of the invention within the scope of the invention. Such modified exemplary embodiments—even if not illustrated in the drawings—are within the scope of the invention.

All disclosed features are per se essential to the invention. The disclosure of the application hereby also fully incorporates the disclosure content of the associated priority documents (copy of the prior application) as well as the cited documents and the described devices from the prior art, also for the purpose of incorporating individual or several features of these documents into one or multiple claims of the present application.

FIG. 1 first of all shows a highly schematic, in particular diagram-like view of a first exemplary embodiment of a system 10 according to the invention, in which a dividing line 11 makes a basic two-split of the diagram into customer side 12 and provider side 13.

On the customer side 12, it can be seen that the terminal device 14 to be provided with a specific function is a smartphone 15 in the present case.

In the present exemplary embodiment, a company (which within the context of the present patent application is the customer) wishes to develop or further develop software for mobile terminal devices, in this case a smartphone 15. In particular, a function for recognizing objects in images is to be integrated within a certain application of the smartphone 15. The customer aims to obtain the function required for this purpose externally (namely from the provider) as a finished solution.

In this context, the customer can make a request 16 to the provider (at 13). This request is then received and processed by a management system 17 of the provider. The management system 17 may in particular comprise one or more system servers 18 of the provider, using which the request is processed.

For example, the customer may submit the request 16 via the provider's product homepage, which request is then received and processed by the management system 17. In particular, the management system 17 can receive data from the customer system or from server(s) 19 provided on the customer side. The server or servers 19 may be the customer servers on which said app for the smartphone 15 (which is to be equipped with said function) runs/is hosted. In particular, the management system 17 can thereby check whether compatibilities are respected. The management system 17 can then select a suitable hardware node of the structure 20 by means of a (hierarchical) structure 20, which in the present case is configured as a tree structure or domain tree. In the present exemplary embodiment, the exemplary hardware nodes are denoted with the numbers 1 to 9.

The management system 17 can thus perform a determination 21 based on the request 16 made as to which nodes in the structure 20 are suitable and, for example, connect the customer server 19 to the corresponding node (in the present case, node 2) or assign it to node 2. The (hardware) node 2 may in this case, for example, map or comprise the function of an object recognition, which is to be used within the app (which runs on the smartphone 15).

This coupling of the node 2 with the server 19 is indicated in FIG. 1 by an arrow 22, which leads from an exemplary hardware module 23 to the customer servers 19. This connection may in particular be a wireless connection, for example an Internet connection or a mobile data connection or the like. The hardware module 23, which will be explained in greater detail below, can for example be arranged in a housing 24 in the type of a server cabinet of the provider or similar.

A plurality of other hardware modules 23 can also be arranged in the housing 24, which constitute physical representations of the other nodes 1 or 3 to 9, for example.

This is for example shown, but merely schematically indicated, in FIG. 3.

In this context, the hardware module 23 can also be regarded as a physical representation of the node 2 since it provides exactly the desired function (in the present case “object recognition”).

FIG. 2 clarifies the set-up or structure of the hardware module 23.

Such a hardware module 23 can in principle be comparable to a mainboard. In the present case, it first of all has connections 25 shown schematically, wherein these can in particular be connections for data transmission (e.g. USB, COM, LAN, etc.), i.e. communication interfaces, and/or connections for the power supply or the like (alternatively, of course, an external power supply can also be omitted in certain application cases, for example in the event that batteries or power packs are installed in the hardware module 23).

In addition to passive elements 26 (such as resistors, capacitors, etc.), according to the invention the hardware module has a controller 27, wherein multiple corresponding controllers 27 can also be provided in particular for redundancy reasons. The controller 27 can, for example, be configured as a controller chip or the like and can also be referred to as an AI agent, which is connected in particular to the connections 25, but also to the neural unit 28, which is still to be described herein.

The neural unit 28, which is also embedded in the hardware module 23, in this case represents the physical representation of a neural network and in this context, also represents the actual function or the actual hardware node 2 (or parts thereof), in particular in interaction with a knowledge base 29, which in the present exemplary embodiment is also embedded in the hardware module 23 and may already be linked to the neural network or the neural unit 28.

Alternatively, however, it is also conceivable that the knowledge base 29 is not integrated into the hardware module 23, but instead the hardware module 23 accesses an externally arranged knowledge base (via remote access, e.g., via Internet or a mobile data connection).

Preferably, the neural unit 28 and the knowledge base 29 are connected to each other, in any case both are connected to the controller 27, which processes and passes on the determined inference data (in particular to the customer).

Referring again to FIG. 1, it can be seen, by way of example only, that the hardware module 23 is thus connected to the customer server 19 and, via said server, also to the smartphone 15, as can be seen from the arrow 30, so that the hardware module 23 as a whole can provide the desired object recognition function on the smartphone 15.

In other words, if the object recognition is to be performed on the smartphone 15, the smartphone 15 is first connected to the customer server 19 and then from the customer server 19 to the hardware module 23.

In the present exemplary embodiment, the hardware module 23 is thus arranged on the provider side (at 13) and not on the customer side (at 12). However, in exemplary embodiments described later, the hardware module 23 can also be integrated into the terminal device 14 itself.

Finally, it should be noted with regard to the exemplary embodiment according to FIG. 1, that this is an exemplary embodiment in which the function desired by the customer could already be provided by the provider's management system 17, since a corresponding structure, which comprised the appropriate node 2, already existed.

In other, non-illustrated cases, building a corresponding structure 20 and/or building of individual nodes 1 to 9 can be carried out first after the customer's request 16. Indeed, if a desired function is available, it can be developed first by the provider upon the specific customer preference.

For this purpose, the provider can train or instruct an appropriate neural network that is capable of implementing the desired function. After completing the training, the provider can then integrate the desired function into its structure 20 and physically manifest it as a neural unit, which is embedded in a (then novel) hardware module 23.

Thus, in this context, a novel hardware module 23 may be created in such a case, for example, and this may be inserted into or added to an existing housing 24, for example, or directly implemented into a terminal device 14.

Overall, the first exemplary embodiment thus provides a function of object recognition for the smartphone 15, which is based on properties or functions of the neural network, in interaction with a knowledge base of expert knowledge. In the present example, the expert knowledge does not relate in particular to the way in which objects are technically recorded or mapped or the like, but rather to knowledge for interpreting the classification results from the neural network or the neural unit (i.e., for example, it may be stored in the knowledge base which recorded structure can be assigned to which real object to be recognized).

FIG. 5A illustrates a second exemplary embodiment of the invention: In FIG. 5, the terminal device 14 is configured as a medical diagnostic tool, in particular an MRI system 31.

In this case, the customer is, for example, a clinic that wants to provide technical support to its medical staff. In this case, a diagnostic procedure such as magnetic resonance tomography is to be complemented by an AI-based analysis.

For this purpose, the customer starts a request 16 regarding a corresponding function. The management system 17 then assigns the request in the tree structure to nodes 4, 6 and 8. In particular, node 4 is subordinate to node 2, for example, and the function of node 4 can be based on functional elements of node 2.

Only by way of example, the tree structure 20 in the exemplary embodiment according to FIG. 5 is identical to that according to FIG. 1, since in both cases these can be image recognition functions. One of the image recognition functions, namely concerning node 4, may therefore be comparable or partially identical to the node designated with 2 in the exemplary embodiment according to FIG. 1.

More specifically, the other two nodes, 6 and 8, then concern the medical and MRI fields, respectively.

A particularity of the invention is that, on the one hand, the functions are represented by neural networks, but on the other hand, the knowledge base is also consulted.

In the present exemplary embodiment, at least one of the modules 23a to 23c comprises an integrated knowledge base. Said base can contain, for example, medical expertise on how to interpret the images of the MRI system, for example with regard to certain diseases that correspond to certain patterns or representations in the images taken.

Therefore, the particular feature is that this expert knowledge of the evaluation of the images is considered in the actual evaluation operations and this expert knowledge is linked to the technical functions.

In the present case, a step 34 takes place in which the nodes 4, 6, 8 or the hardware modules 23a to 23c allocated in the present case are coupled with the customer computer or customer server 19.

In a next step, the MRI system 31 will now determine or record data of a patient and forward (represented by the arrow 32) this data to the server 19 of the customer, wherein the data is then forwarded from the server 19, according to the arrow 33, to the hardware modules 23, which perform an AI-based analysis (based on the neural network and the expert knowledge of the knowledge base). The results of the analysis are then returned to the customer or server 19, according to arrow 34, and transmitted to the responsible physician 35 (according to arrow 36), for example. The physician 35 is thus supported in his medical assessment and can rely on the determined AI analysis by the provider, which is based on both technical evaluation functions or algorithms and expert knowledge of the knowledge base.

The exemplary embodiment according to FIG. 6 shows a use case in which the terminal device 14 is configured as a drone 37. In this case, the manufacturer of flying drones would like to develop a new drone that can be operated autonomously.

A number of functions are required to this end. For example, an optimal route is to be selected based on the current position of the drone and the destination. In particular, objects and/or obstacles are to be recognized (e.g., by an internal camera or radar) and, if necessary, the flight route adjusted accordingly.

In the present exemplary embodiment, the system 10″, merely by way of example, comprises a corresponding structure 20, and this structure may correspond to or differ from the structures of the above-mentioned exemplary embodiments in terms of its functions and/or its set-up. By way of example, two nodes 7 and 8 are selected for implementing the functions. In contrast to the above examples, these are both implemented in the same hardware module 23′.

The particularity of the present exemplary embodiment lies, among other things, in the fact that the module 23′ is precisely not accommodated in the housing 24, but is manufactured on the provider side 13 or is already present and is then delivered or shipped to the customer side 12 and can be (physically) installed or embedded in the drone 37. In any case, this concerns the case that the requirements regarding, for example, installation space, weight or costs of the drone allow this. In particular, this solution thus allows real-time access to the functions provided by the hardware module 23′.

Alternatively, however, it could be possible for the hardware module 23′ to remain on the provider side (e.g., in the housing 24) and for the drone 37 to establish a connection (for example, via the server 19) to the hardware module 23′, at least to the extent permitted by the functions and the connection speed.

Finally, a last exemplary embodiment according to FIG. 7 shows a system 10′″ with a robot 38 as the terminal device 14. In this case, a manufacturer of robots wants to equip its robots with capabilities required for autonomous functions. Corresponding capabilities are, for example, object and obstacle recognition, speech recognition, speech generation, further acoustic perception, the ability to avoid obstacles, movement functions (such as bending, turning, standing up) or the like.

The customer decides to use the provider's ready-made solution. In this exemplary embodiment, various functions are again assigned to different hardware nodes 5, 6, and 7, each of which is implemented in separate hardware modules 23′a to 23′c. These hardware modules are typically inserted directly and physically into the robot 38 (but can also theoretically remain on the provider side 13, as in the other exemplary embodiments).

Finally, for the sake of completeness, reference is made to FIG. 4, which is intended to clarify that various nodes 1 to 9 of the structure 20 can be arranged or kept in various locations, distributed worldwide. In the exemplary embodiments shown, for example, the hierarchically upper nodes 1 to 3 are implemented by hardware modules (not shown), which are stored in a first housing 39, which is located in Europe, for example, while further nodes 4 to 9 (or the corresponding hardware modules) are located in another housing 40, which is located in America.

Any advantages described with reference to the individual exemplary embodiments are always intended to apply to the other exemplary embodiments as well and are not intended to be limited to individual generic types, such as drones or cell phones.

1-10. (canceled)

11. A method for providing functions for a terminal device of a customer, comprising the steps of:
registering a functional configuration desired by the customer using a management system;
creating or providing at least one hardware module that comprises at least one controller and a neural unit as a physical representation of a neural network, in consideration of the desired functional configuration;
connecting the hardware module to a knowledge base with digitized expert knowledge, which expert knowledge in particular may be related to the special field of the terminal device; and
connecting the hardware module to the terminal device.

12. The method according to claim 11, including protecting the at least one hardware module with a housing.

13. The method according to claim 11, including integrating the hardware module into the terminal device.

14. The method according to claim 13, including integrating the Howard where module physically into the terminal device.

15. The method according to claim 11, including operating the hardware module autonomously from the terminal device.

16. The method according to claim 15, including operating the hardware module autonomously from the terminal device together with further similar hardware modules at a common location or in a common housing.

17. The method according to claim 11, wherein the knowledge base is integrated or embedded in the hardware module.

18. The method according to claim 17, wherein the knowledge base is integrated or embedded physically in the hardware module.

19. The method according to claim 11, wherein the terminal device is a machine, a vehicle, a robot, a cell phone, a portable computer, a medical technology device or system or a drone, or terminal devices with analog or comparable modes of operation.

20. The method according to claim 19, wherein the terminal device comprises an operating system.

21. The method according to claim 11, further comprising the step of:
training the neural network by using FPGAs or ASICs.

22. The method according to claim 21, including training the neural network after transfer into the neural unit of the hardware module.

23. The method according to claim 11, further comprising the step of:
transmitting data from the terminal device to the hardware module, and evaluating or processing the data using the neural network, and transmitting a result of the evaluation or processing to the terminal device.

24. The method according to claim 23, wherein the step of transmitting data includes transmitting data from the terminal device to the controller of the hardware module.

25. The method according to claim 23, wherein the step of evaluating or processing the data using the neural network takes into consideration the knowledge base.

26. The method according to claim 11, wherein the at least one hardware module includes a plurality of hardware modules, further comprising the step of:
managing or providing a structure of functions for hardware nodes relating to the terminal device, wherein the hardware nodes are assigned to the hardware modules.

27. The method according to claim 26, wherein the step of managing or providing a structure of functions for the hardware nodes uses the management system.

28. A system for providing functions for a terminal device of a customer, comprising: at least one hardware module; a subsystem that assigns the at least one hardware module to a functional configuration desired by the customer, the hardware module including at least one controller and a neural unit as a physical representation of a neural network; and a knowledge base with digitized expert knowledge, which knowledge base at least is in communication with the hardware module.

29. The system according to claim 28, wherein the knowledge base is integrated or embedded into the hardware module, and/or the hardware module is integratable or is integrated in the terminal device.
